(19) United States
(12) Patent Application Publication
(10) Pub. No.: US 2021/0082402 A1
(43) Pub. Date: Mar. 18, 2021

(54) SYSTEM AND METHOD FOR ACCENT CLASSIFICATION

(71) Applicant: Cerence Operating Company, Burlington, MA (US)

(72) Inventors: Yang SUN, Burlington, MA (US); Junho PARK, Burlington, MA (US); Goujin WEI, Burlington, MA (US); Daniel WILLETT, Walluff (DE)

(73) Assignee: Cerence Operating Company, Burlington, MA (US)

(21) Appl. No.: 16/570,122

(22) Filed: Sep. 13, 2019

(51) Int. Cl. G10L 15/07; G10L 13/10; G10L 21/02; G10L 15/16; G10L 15/18

(52) U.S. Cl. CPC G10L 15/07; G10L 13/10; G10L 15/1807; G10L 15/16; G10L 21/02

(57) ABSTRACT

A system and/or method receives speech input including an accent. The accent is classified with an accent classifier to yield an accent classification. Automatic speech recognition is performed based on the speech input and the accent classification to yield an automatic speech recognition output. Natural language understanding is performed on the speech recognition output and the accent classification determining an intent of the speech recognition output. Natural language generation generates an output based on the speech recognition output and the intent and the accent classification. An output is rendered using text to speech based on the natural language generation and the accent classification.

### BACKGROUNG OF THE DISCLOSURE

### 1. Field of the Disclosure

The present disclosure relates to dialogue systems and particularly to dialogue systems that estimates a speaker's accent with an accent classifier.

### 2. Description of Related Art

Dialogue systems which use automatic speech recognition (ASR) are increasingly being deployed in a variety of business and enterprise applications. Moreover, there has been a shift from command-based dialog systems to conversational systems. Unlike command-based systems that require constrained command-language, have a predictable syntax, utilize short utterances, and depend on minimal context or simple semantics, conversational systems are designed for unconstrained spontaneous language with mixed length utterances, unpredictable syntax, and depend on complex semantics.

There exist many varieties of language dialects which are often not mutually intelligible. For example, there are manifold varieties of Chinese dialects. Standard Mandarin is based on the Beijing dialect. Although Standard Mandarin is the only official language in both mainland China and Taiwan, recognizable accents persist under the influence of local dialects that are usually distributed regionally. Northern dialects in China tend to have fewer distinctions than southern dialects. Other factors, such as the history and development of cities or education level have contributed to the diversity of dialects.

Accents are a primary sources of speech variability. Accented speech specifically poses a challenge to ASR systems because ASR systems must be able to accurately handle speech from a broad user base with a diverse set of accents. Current systems fail to account for the above and other factors.

### SUMMARY

The present disclosure provides a system and method that estimates a speaker's accent with an accent classifier.

The present disclosure further provides a system and method that receives speech input including an accent. The accent is classified with an accent classifier to yield an accent classification. Automatic speech recognition is performed based on the speech input and the accent classification to yield an automatic speech recognition output. Natural language understanding is performed on the speech recognition output determining an intent of the speech recognition output. Natural language generation generates an output based on the speech recognition output and the intent. An output is rendered using text to speech based on the natural language generation.

The present disclosure further provides such a system and method in which natural language understanding is performed on the speech recognition output, further based on the accent classification.

The present disclosure further provides such a system and method in which an intent is further based on the accent classification.

The present disclosure further provides such a system and method in which natural language generation is further based on the accent classification.

The present disclosure further provides such a system and method in which rendering an output is further based on the accent classification.

The present disclosure further provides such a system and method in which the performing natural language understanding on the speech recognition output, the determining an intent, and the using natural language, and rendering an output are based on the accent classification.

### BRIEF DESCRIPTION OF THE FIGURES

The accompanying drawings illustrate aspects of the present disclosure, and together with the general description given above and the detailed description given below, explain the principles of the present disclosure. As shown throughout the drawings, like reference numerals designate like or corresponding parts. Since outputs of a first component are inputs of a second component, as used herein, “input {like reference numeral}” and “output {like reference numeral}” are the same.

FIG. 1 shows an exemplary system architecture according to the present disclosure.

FIG. 2 shows an exemplary embodiment of a dialog system according to the present disclosure.

FIG. 3 shows an exemplary embodiment of an ASR system and an accent classifier component of the dialog system.

FIG. 4 is an exemplary logic flow diagram of a signal processor component and the accent classifier component of the dialog system.

FIG. 5 is an example neural network used by the accent classifier component.

FIG. 6 is an exemplary logic flow diagram of an ASR component of the dialog system.

FIG. 7 is an exemplary logic flow diagram of an NLU component of the dialog system.

FIG. 8 is another exemplary logic flow diagram of an NLU component of the dialog system.

FIG. 9 is yet another exemplary logic flow diagram of an NLU component of the dialog system.

FIG. 10 is an exemplary logic flow diagram of a dialog manager component of the dialog system.

FIG. 11 is another exemplary logic flow diagram of a dialog manager component of the dialog system.

FIG. 12 is yet another exemplary logic flow diagram of a dialog manager component of the dialog system.

FIG. 13 is an exemplary logic flow diagram of an NLG and TTS component of the dialog system.

### DETAILED DESCRIPTION

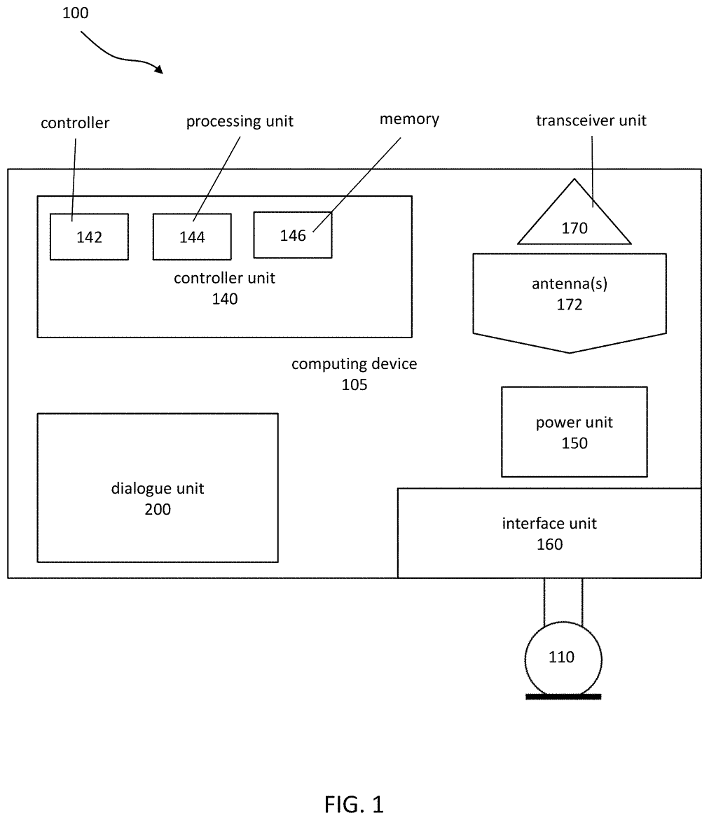

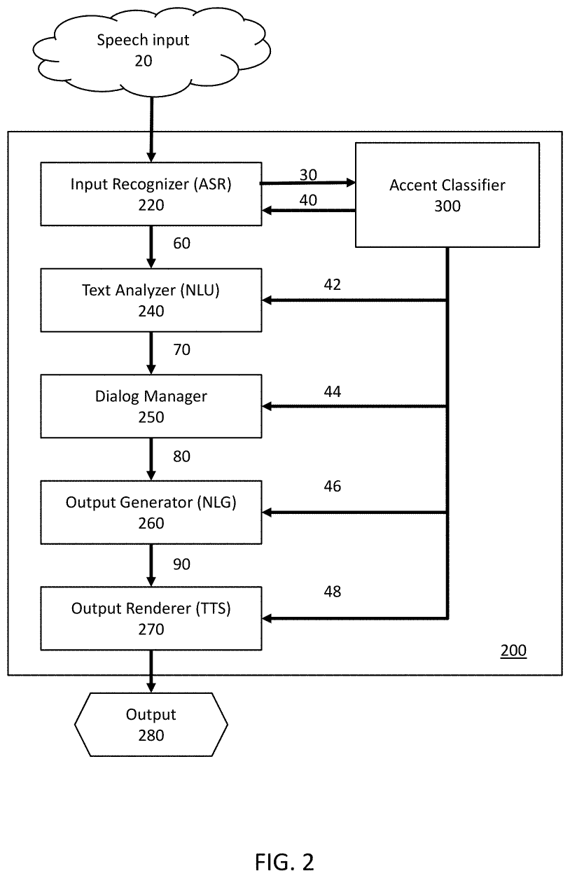

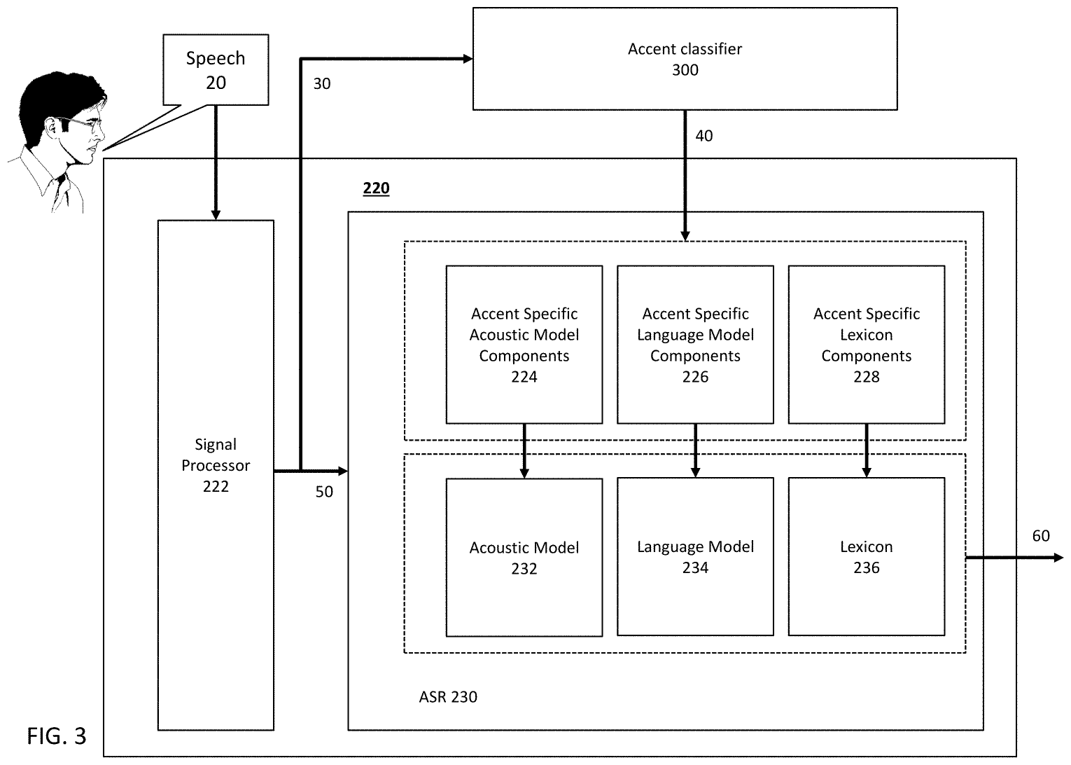

Referring to the drawings and, in particular to FIG. 1, an example system architecture for a personal conversation system is generally represented by reference numeral 100, hereinafter “system 100”. System 100 includes dialog unit 200 that estimates a speaker's accent with an accent classifier 300, shown in FIG. 2 and FIG. 3.

Referring back to FIG. 1, system 100 includes the following exemplary components that are electrically and/or communicatively connected: a microphone 110 and a computing device 105.

Microphone 110 is a transducer that converts sound into an electrical signal. Typically, a microphone utilizes a diaphragm that converts sound to mechanical motion that is in turn converted to an electrical signal. Several types of microphones exist that use different techniques to convert, for example, air pressure variations of a sound wave into an electrical signal. Nonlimiting examples include dynamic microphones that use a coil of wire suspended in a magnetic field; condenser microphones that use a vibrating diaphragm as a capacitor plate; and piezoelectric microphones that use a crystal of made of piezoelectric material. A microphone according to the present disclosure can also include a radio transmitter and receiver for wireless applications.

Microphone 110 can be directional microphones (e.g. cardioid microphones) so that focus on a direct is emphasized or an omni-directional microphone. Microphone 110 can be one or more microphones or microphone arrays.

Computing device 105 can include the following: a dialog unit 200; a controller unit 140, which can be configured to include a controller 142, a processing unit 144 and/or a non-transitory memory 146; a power source 150 (e.g., battery or AC-DC converter); an interface unit 160, which can be configured as an interface for external power connection and/or external data connection such as with microphone 110; a transceiver unit 170 for wireless communication; and antenna(s) 172. The components of computing device 105 can be implemented in a distributed manner and across one or more networks such local area networks, wide area networks, and the internet (not shown).

Dialog unit 200 is dialog or conversational system intended to converse or interface with a human.

In the example of FIG. 2, dialog unit 200 includes the following components: an input recognizer 220, a text analyzer 240, an dialog manager 250 an output generator 260, an output renderer 270, and an accent classifier 300 that provides input to one or more of foregoing components.

Input recognizer 220 includes a signal processor 222 and an automatic speech recognition system (ASR) that transcribes a speech input to text, shown in FIG. 3. Input recognizer 220 receives as input, for example, an audio signal of a user utterance and generates one or more transcriptions of the utterance. As an example (“Italian restaurant example”), input recognizer 220 converts a spoken phrase or utterance of a user such as, “find an Italian restaurant nearby” to text.

Text analyzer 240 is a Natural Language Understanding (NLU) component that receives textual input and determines one or more meanings behind the textual input that was determined by input recognizer 220. In example embodiments, text analyzer 240 determines a meaning of the textual input in a way that can be acted upon by dialog unit 200. Using the Italian restaurant example, text analyzer 240 detects the intentions of the utterance so that if input recognizer 220 converts “find an Italian restaurant near me” to text, text analyzer 240 understands that the user wants to go to an Italian restaurant.

Dialog manager 250 is an artificial intelligence (also known as machine intelligence) engine that imitates human “cognitive” functions such as “learning” and “problem solving”. Using the Italian restaurant example, dialog manager 250 looks for a suitable response to the user's utterances. Dialog manager 250 will search, for example, in a database or map, for the nearest Italian restaurant.

Dialog manager 250 can provide a list of Italian restaurants, in certain embodiments ranking by the Italian restaurants by distance and/or by reviews to generate the final recommendation using the output renderer that will be discussed herein.

It has been found by the present disclosure that people from same region share similar traditions. By detecting a user accent to represent the user's region, the system can identify and suggest regional preference. For example, in China, people from Henan province like noodles much more than people from Sichuan province. So, dialog manager can recommend more noodle restaurant to user who has strong Henan province accent no matter s/he is in Sichuan or Henan now.

Output generator 260 is a Natural Language Generation (NLG) component that generates phrases or sentences that are comprehensible to a human from its input.

In the Italian restaurant example, output generator 260 arranges text in so that the text sounds natural and imitates how a human would speak.

Output renderer 270 is a Text-to-Speech (TTS) component that outputs the phrases or sentences from output generator 260 as speech. In example embodiments, output renderer 270 converts texts into sound using speech synthesis. In the Italian restaurant example, output renderer 270 produces audible speech such as, “The nearest Italian restaurant is Romano's. Romano's is two miles away.”

Accent classifier 300 provides input for one or more of input recognizer 220, text analyzer 240, dialog manager 250, output generator 260, and output renderer 270 to increase recognition and transcription performance of the components individually and in combination.

Speech input from block 20 is fed to input recognizer 220. An output of input recognizer 220 is fed to accent classifier 300 by input 30. An accent prediction from accent classifier 300 is fed back to input recognizer 220 by input 40 and used to generate another output of input recognizer 220 that is fed into text analyzer 240 by input 60. Text analyzer 240 also receives output from accent classifier 300 as input 42.

An output of text analyzer 240 is fed to dialog manager 250 by input 70. Dialog manager 250 also receive output from accent classifier 300 as input 44.

An output of dialog manager 250 is fed to output generator 260 by input 80. Output generator 260 also receive output from accent classifier 300 as input 46.

An output of output generator 260 is fed to output renderer 270 by input 90. Output renderer 270 also receive output from accent classifier 300 as input 48. Output renderer generates output 280 as a result.

In example embodiments, outputs 40, 42, 44, 46, 48 can be the same. In other example embodiments, outputs 40, 42, 44, 46, 48 can be different from each other.

Reference is now made to FIG. 3, showing an example flow chart of input recognizer 220 and accent classifier 300.

A person produces an utterance or speech as indicated by block 20. An audio signal thereof, including speech to be recognized, is received by signal processor 222. This can be, for example, by way of an audio signal from microphone 110.

Signal processor 222 extracts acoustic features from the audio signal.

Output from signal processor 222 is fed into accent classifier 300 as input 30 and into ASR 230 as input 50.

ASR 230 includes acoustic model 232, language model 234, and lexicon 236 to which input 50 is applied.

Acoustic model 232 is a model that represents a relationship between a speech signal and linguistic units that make up speech such as phonemes. In example embodiments, acoustic model 232 includes statistical representations of the sounds that make up each sub-word unit.

Language model 234 is statistical probability distribution over word sequences to provide context to distinguish among similar sounding words and phrases, for example. In embodiments, a language model 234 exists for each language. In embodiments, language model 234 contains probability distributions of sequences of words for all possible contexts, not simply those that are similar sounding.

Lexicon 236 is a vocabulary for ASR 230 and maps sub-word units into words.

In summary, acoustic model 232 predicts a probability for sub-word units, language model 234 determines a probability in word sequences. Lexicon 236 bridges the gap between acoustic model 232 and language model 234 by mapping sub-word units into words.

Accent classifier 300 generates an accent prediction as output 40. Output 40 is fed into ASR 230.

In this example, output 40 is fed into one or more of accent specific acoustic model components 224 which is used to generate an input for acoustic model 232, accent specific language model components 226 which is used to generate an input for language model 234, and accent specific lexicon components 228 which is used to generate an input for lexicon 236.

Accent specific acoustic model components 224 are components that inform acoustic model 232 based on a detected accent.

Accent specific language model components 226 are components that inform language model 234 based on a detected accent.

Accent specific lexicon components 228 are components that inform lexicon 236 based on a detected accent.

ASR 230 generates an output 60, based on accent classifier 300 for use as input.

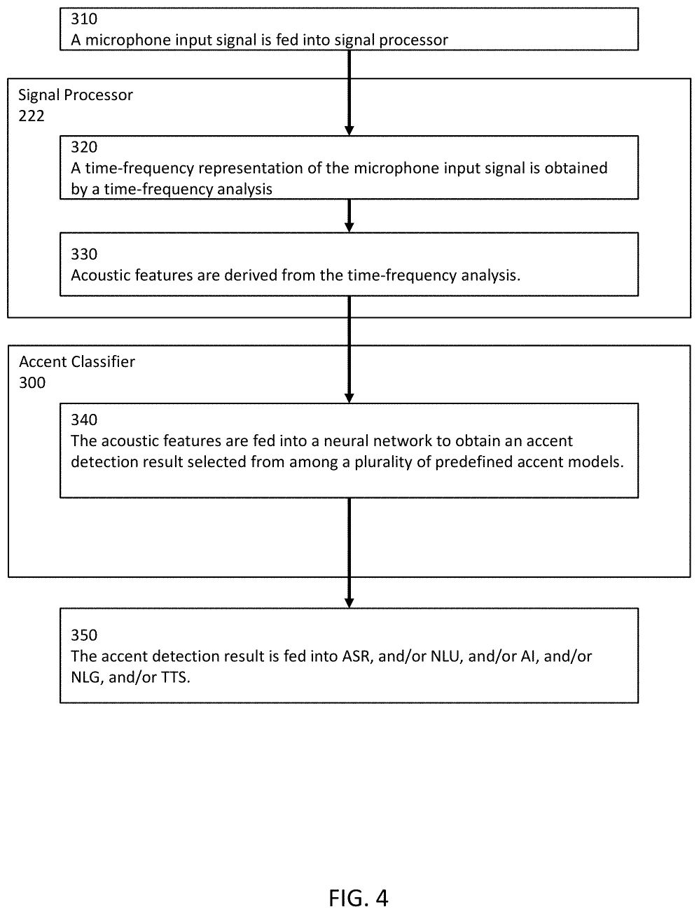

Operation of accent classifier 300 to generate a prediction result will now be described with reference to FIG. 4.

At step 310, a speech is captured by a microphone, such as microphone 110, and a microphone input signal of the speech is fed into signal processor 222.

At step 320, A time-frequency representation of the microphone input signal is obtained by a time-frequency analysis.

For example, signal processor 222 obtains acoustic features of the audio signal, for example, by generating a time-frequency representation of the microphone input signal such as a Short-time Fourier transform (STFT) or Fast Fourier Transform (FFT). The acoustic features can be determined, for example, by binning energy coefficients, using a mel-frequency cepstral coefficient (MFCC) transform, using a perceptual linear prediction (PLP) transform, or using other techniques. In some implementations, the logarithm of the energy in each of various bands of the FFT may be used to determine acoustic features. Metadata features can include, among others, an application ID, a speaker ID, a device ID, a channel ID, a date/time, a geographic location, an application context, and a dialog state. Metadata can get represented as one-hot vector or via means of embedding as model input.

At step 330, acoustic features are derived from the time time-frequency analysis. Example acoustic features include: the stream of MFCC, SNR estimate, reverberation time.

At step 340, acoustic features are fed into a neural network to obtain an accent prediction result from among a plurality of pre-defined accents.

Pre-defined accents include accents of a given language. Nonlimiting examples of pre-defined accents include major accents of: Mandarin including, Changsha, Jinan, Nanjing, Lanzhou, Tangshan, Xi'an, Zhengzhou, Hong Kong, Taiwan, Malaysia; English including US English, British English, Indian English, Australian English; Spanish including Spanish in Spain and Spanish from Latin America; German including High German, Swiss German, Austrian German; and French including Metropolitan French, and Canadian French.

In example embodiments of the present disclosure, where there are multiple correlated utterances in succession, such as dictation applications, an accent can be estimated on one utterance and applied in decoding of the next.

At step 350, an accent detection prediction is fed into ASR 230 (FIG. 2, output 40), and/or text analyzer 240 (FIG. 2, output 42), and/or dialog manager 250 (FIG. 2, output 44), and/or output generator 260 (FIG. 2, output 46), and/or output renderer 270 (FIG. 2, output 48).

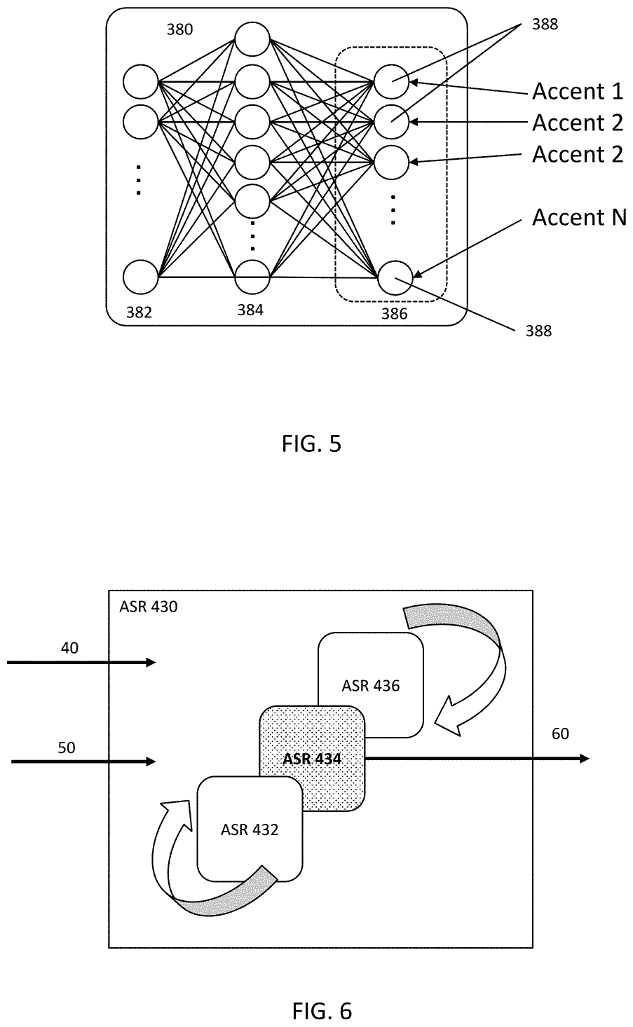

FIG. 5 is an example neural network, neural network 380. Neural network has an input layer 382, one or more hidden layers 384, and an output layer 386. Neural network 380 is trained to estimate a posterior probability that certain combinations of acoustic features represent a certain accent.

Examples of neural networks 380 include a feedforward neural network, unidirectional or bidirectional recurrent neural network, a convolutional neural network or a support vector machine model.

In an example embodiment, the output layer 386 has a size N corresponding to the number of accents to be classified. The output layer 386 has one node 388 per accent. During prediction phase, Neural network 380 outputs an N dimensional posterior probability vector (sum up to 1) per speech frame. In example embodiments, a speech frame can be 10 or 20 milliseconds. In other example embodiments, a speech from can be in in a range of 1 to 100 milliseconds, preferably 10 to 50 milliseconds, and most preferably 10 to 20 milliseconds. The node with the maximum probability is the prediction of the neural network for that frame. To obtain the accent prediction at utterance level, all the predicted posterior probability vectors of the belonging frames are summed up. The accent with the maximum probability of the sum-up vector is the accent prediction for the whole utterance.

FIG. 6 shows another example of ASR 230, ASR 430. ASR 430 receives input 40 and input 50. Based on these inputs, ASR 430 selects one ASR model of a plurality of ASR models 432, 434 and 436 that run in parallel until an accent decision is made. In this example, ASR 430 selects ASR model 434 to be used for generating output 60.

Unlike the example of FIG. 3 where ASR selects each component 224, 226, 228 individually, in the example of FIG. 6, ASR selects among discrete ASR systems dedicated to a single language. That is, in the example of FIG. 6, each accent is considered an independent language by the system.

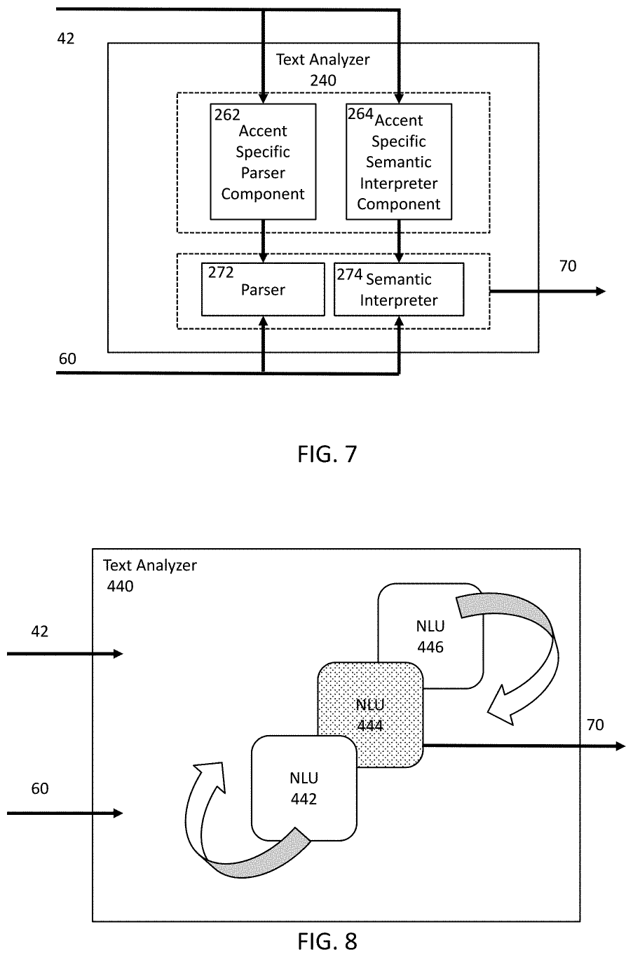

FIG. 7 shows an example of text analyzer 240. Text analyzer 240 receives input 42 and input 60. Input 42 is processed by accent specific parser component 262 and accent specific semantic interpreter component 264. Accent specific parser component 262 feeds parse 272. Accent specific semantic interpreter component 264 feeds semantic interpreter 274. Using these feeds, text analyzer 240 generates output 70.

FIG. 8 shows another example of text analyzer 240, text analyzer 440. Text analyzer 440 receives input 42 and input 60. Based on these inputs, text analyzer 440 selects one NLU model of a plurality of NLU models 442, 444, and 446. In this example, text analyzer 440 selects NLU model 444 to be used as output 70.

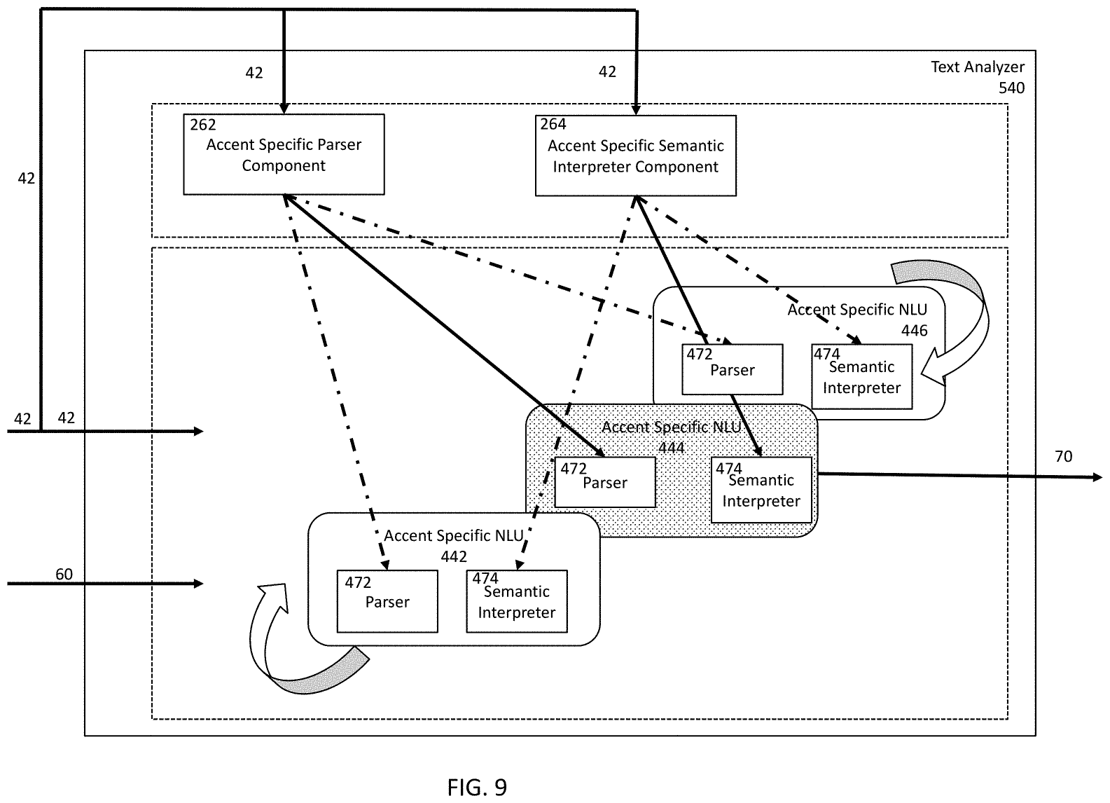

Combinations of text analyzer 240 and text analyzer 440 are envisioned, for example as in FIG. 9.

In FIG. 9, text analyzer 540 receives inputs 42 and 60. Input 42 is fed into an accent specific component that is used to select one NLU model of a plurality of NLU models 442, 444, and 446. In this example, text analyzer 440 selects NLU model 444 to be used as output 70. In this embodiment, the accent specific components include an accent specific parser component 262 and an accent specific semantic interpreter component 264 that informs a respective parser 472 and semantic interpreter 474 of a plurality of NLU models 442, 444, and 446

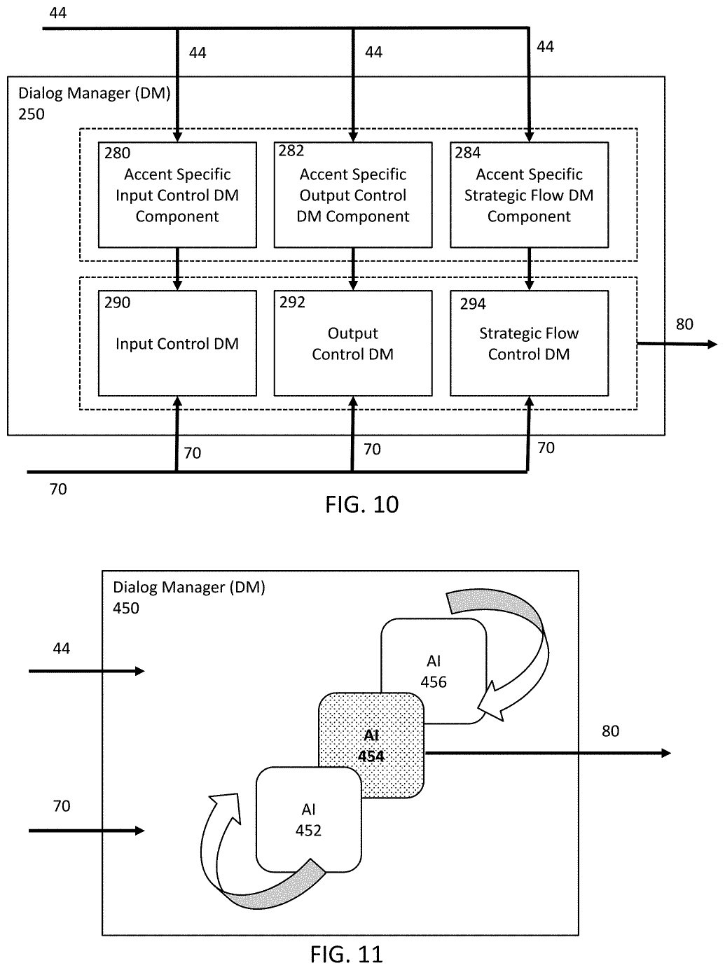

FIG. 10 shows an example of dialog manager 250. Dialog manager 250 receives input 44 and input 70. An accent specific control DM component 280, an accent specific output control DM component 282, and an accent specific strategic flow DM component 284 receives input 44 and informs input control DM 290, output control DM 292, and strategic flow control DM 294, respectively. Each of input control DM 290, output control DM 292, and strategic flow control DM 294 also receives input 70 so that dialog manager 250 generates output 80.

FIG. 11 shows another example of dialog manager 250, dialog manager 450. Dialog manager 450 receives input 44 and input 70. Based on these inputs, Dialog manager 450 selects one AI model of a plurality of AI models 452, 454, and 456. In this example, dialog manager 450 selects AI model 454 to be used as output 80.

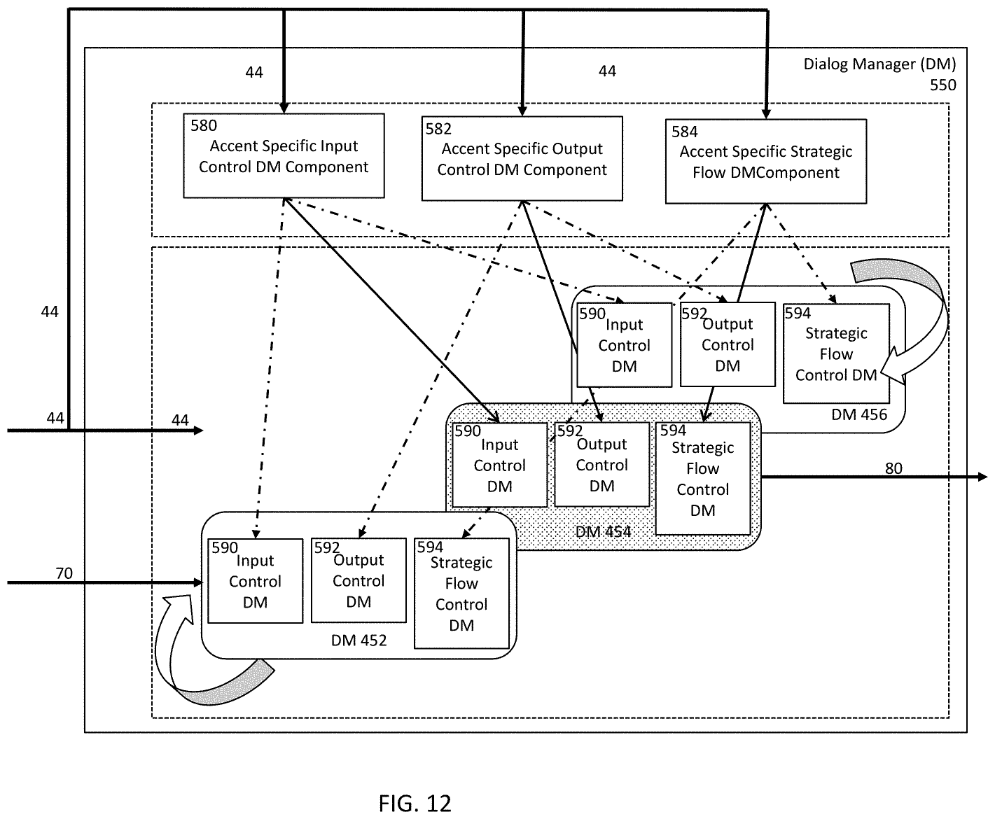

Combinations of dialog manager 250 and dialog manager 450 are envisioned as shown in FIG. 12. Dialog manager 550 receives input 44 and input 70. Based on these inputs, dialog manager 450 selects one AI model of a plurality of AI models 452, 454, and 456. In this example, dialog manager 450 selects AI model 454 to be used as output 80. However, unlike the embodiment shown in FIG. 11, in this embodiment the AI model selection is informed by an accent specific component that includes an accent specific input control dialog manager component 580, an accent specific output control dialog manager component 582, and an accent specific strategic flow dialog manager component 584, each of which informs the selection of one AI model of a plurality of AI models 452, 454, and 456 that each include. An input control dialog manager 590, an output control dialog manager 592, and a strategic flow control dialog manager 594. Dialog manager 550 generates output 80.

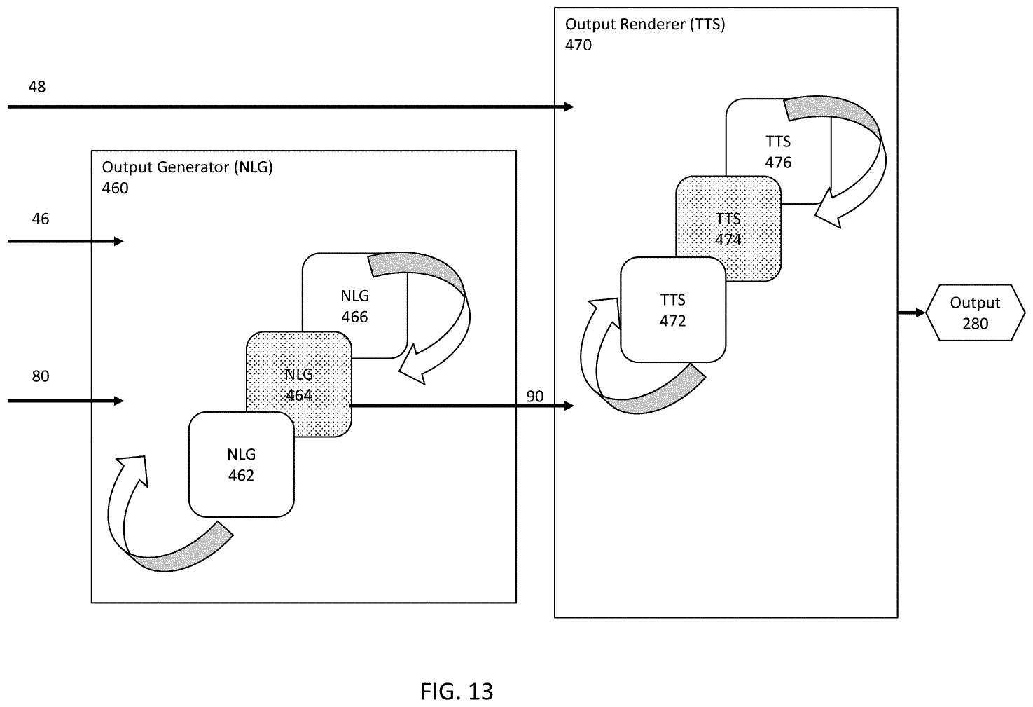

FIG. 13 shows an example of output generator 460 in conjunction with output renderer 470.

Output generator 460 receives input 46 and input 80. Based on these inputs 46 and 80, output generator 460 selects one NLG model of a plurality of NLG models 462, 464, and 466. In this example, output generator 460 selects NLG model 464 to be used as output 90.

Output 90 and input 48 are fed into output renderer 470. Based on output 90/input 90 and input 48, output renderer 470 selects one TTS model of a plurality of TTS models 472, 474, and 476. In this example, output renderer 470 selects TTS model 474 to be used as output 280.

Operation of system 100 will now be described by way of an example wherein a British English speaker is interfacing with system 100.

System 100 receives an audio signal from microphone 110 that includes speech from block 20 of a British English speaker.

The speech signal is fed into signal processor 222. Signal processor feeds ASR 230 input 50 and Accent classifier 300 input 30. Input 30 is the same as input 50.

From input 30, accent classifier 300 uses neural network 380 to detect the accent as British English, not an American English, Australian English or Indian English. Thus, a British accent signal will be passed to ASR 230 as input 40.

In one example, ASR 230 can switch to a British ASR, as in FIG. 6. In another example, ASR 230 can use a British acoustic model, a British language model and British lexicon which covers expressions only British would use, as shown in FIG. 3.

After ASR 230 recognizes the audio and converts the audio to text, the text will be fed into text analyzer 240 to process and understand the meaning and intentions of the text.

An accent tag can be used as an input to an NLU model of text analyzer 240 so that the model can give more precise understanding of the British sentence. For example, ‘football’ for British people is played with a round ball that can be kicked and headed.

Once text analyzer 240 understands the sentence, the sentence is fed to dialog manager 250. It has been found by the present disclosure that accents, which suggest where the user came from, are more useful for giving AI solutions than a geolocation of the dialog. For example, if dialog is happening in New York City and the user's accent is recognized by accent classifier 300 as British, then AI can recommend British-friendly solutions, for example, in terms of food, music and etc.

After dialog manager 250 completes processing, output generator 260 formulates a response based on the dialog manager recommendation. Advantageously, having an accent prediction helps complete a sentence more quickly and naturally according to British grammar and/or expressions.

Output from output generator 260 is used to speak a response to the user by output renderer 270 using TTS. In embodiments, a user can select a TTS in the same accent as themselves or another, for example, to make it sound more enjoyable.

It has been found by the present disclosure that accents frequently occur at a word level rather than utterance level. Not all words in one accented utterance will be pronounced in an accent way. Thus, the present disclosure alleviates problems that exist with fast accent classification that are less accurate. Advantageously, the present disclosure uses a decision process that waits until enough information is available. To avoid high latency, the system can utilize those estimated accents which are estimated from a first utterance and subsequently apply those to a second utterance.

It has also been found by the present disclosure that better ASR outputs can improve the NLU/NLG performance. Furthermore, an accent-specific NLU/NLG system can take many regional preferences/biases into consideration to improve the dialog system. Moreover, the same accent can be used in TTS to please the users with their mother tongue. Such personalization is particularly desirable.

### Experimental

Data using the systems and method of the present disclosure for the Mandarin language was collected. The complete dataset has about 30 speakers per accent, and three hundred utterances per speaker, covering fifteen different Chinese accents, within which eight accents are considered as heavy accents spoken in eight regions, such as Changsha, Jinan, Lanzhou, Nanjing, Tangshan, Xi'an and Zhengzhou. The remaining seven accents are light ones from Beijing, Changchun, Chengdu, Fuzhou, Guangzhou, Hangzhou, Nanchang and Shanghai.

By using an accent-specific lexicon component, up to relative 37% Character Error Rate Reduction (CERR) on heavy accented data was observed. Results are summarized in the table below. The last column of Table 1 indicates the relative gains using accent-specific lexicon component over the baseline.

TABLE 1

| | | CER | CERR |
|---|---|---|---|
| | Testset | baseline | accent_lexicon gains |
| Heavy Accent | Changsha | 6.88 | +14.79% |
| | Jinan | 9.19 | +22.68% |
| | Lanzhou | 14.42 | +20.93% |
| | Nanjing | 9.83 | +19.11% |
| | Tangshan | 7.22 | +8.27% |
| | Xi'an | 12.39 | +37.75% |
| | Zhengzhou | 10.49 | +31.12% |

It should be understood that elements or functions of the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

While the present disclosure has been described with reference to one or more exemplary embodiments, it will be understood by those skilled in the art, that various changes can be made, and equivalents can be substituted for elements thereof without departing from the scope of the present disclosure. In addition, many modifications can be made to adapt a particular situation or material to the teachings of the present disclosure without departing from the scope thereof. Therefore, it is intended that the present disclosure will not be limited to the particular embodiments disclosed herein, but that the disclosure will include all aspects falling within the scope of a fair reading of appended claims.

Claimed is:

1. A computer-implemented method comprising:
receiving speech input, the speech including an accent;
classifying the accent with an accent classifier to yield an accent classification;
performing automatic speech recognition based on the speech input and the accent classification to yield an automatic speech recognition output;
performing natural language understanding on the speech recognition output determining an intent of the speech recognition output;
using natural language generation to generate an output based on the speech recognition output and the intent; and
rendering an output using text to speech based on the natural language generation.

2. The computer-implemented method according to claim 1, wherein the performing natural language understanding on the speech recognition output is further based on the accent classification.

3. The computer-implemented method according to claim 1, wherein the determining an intent is further based on the accent classification.

4. The computer-implemented method according to claim 1, wherein using natural language generation is further based on the accent classification.

5. The computer-implemented method according to claim 1, wherein the rendering an output is further based on the accent classification.

6. The computer-implemented method according to claim 1, wherein the performing natural language understanding on the speech recognition output, the determining an intent, the using natural language generation, and the rendering an output are further based on the accent classification.

7. A computer program product residing on a non-transitory computer readable storage medium having a plurality of instructions stored thereon which, when executed across one or more processors, causes at least a portion of the one or more processors to perform operations comprising:
receiving speech input, the speech including an accent;
classifying the accent with an accent classifier to yield an accent classification;
performing automatic speech recognition based on the speech input and the accent classification to yield an automatic speech recognition output;
performing natural language understanding on the speech recognition output determining an intent of the speech recognition output;
using natural language generation to generate an output based on the speech recognition output and the intent; and
rendering an output using text to speech based on the natural language generation.

8. The computer program product according to claim 7, wherein the performing natural language understanding on the speech recognition output is further based on the accent classification.

9. The computer program product according to claim 7, wherein the determining an intent is further based on the accent classification.

10. The computer program product according to claim 7, wherein using natural language generation is further based on the accent classification.

11. The computer program product according to claim 7, wherein the rendering an output is further based on the accent classification.

12. The computer program product according to claim 7, wherein the performing natural language understanding on the speech recognition output, the determining an intent, the using natural language generation, and the rendering an output are further based on the accent classification.

13. A computing system including one or more processors and one or more memories configured to perform operations comprising:
receiving speech input, the speech including an accent;
classifying the accent with an accent classifier to yield an accent classification; performing automatic speech recognition based on the speech input and the accent classification to yield an automatic speech recognition output;
performing natural language understanding on the speech recognition output determining an intent of the speech recognition output;
using natural language generation to generate an output based on the speech recognition output and the intent; and
rendering an output using text to speech based on the natural language generation.

14. The computing system according to claim 13, wherein the performing natural language understanding on the speech recognition output is further based on the accent classification.

15. The computing system according to claim 13, wherein the determining an intent is further based on the accent classification.

16. The computing system according to claim 13, wherein using natural language generation is further based on the accent classification.

17. The computing system according to claim 13, wherein the rendering an output is further based on the accent classification.

18. The computing system according to claim 13, wherein the performing natural language understanding on the speech recognition output, the determining an intent, the using natural language generation, and the rendering an output are further based on the accent classification.
